(19) United States
(12) Patent Application Publication
(10) Pub. No.: US 2024/0378836 A1
(43) Pub. Date: Nov. 14, 2024

(54) CREATION OF VARIANTS OF AN ANIMATED AVATAR MODEL USING LOW-RESOLUTION CAGES

(71) Applicant: Roblox Corporation, San Mateo, CA (US)

(72) Inventors: Maurice Kyojin CHU, Redwood City, CA (US); Ronald Matthew GRISWOLD, Van Nuys (CA); Jihyun YOON, Foster City, CA (US); Michael Vincent PALLESCHI, Belmont, CA (US); Adam Tucker BURR, Suffern, NY (US); Adrian Paul LONGLAND, Redwood City, CA (US); Ian SACHS, Corte Madera, CA (US); Kiran BHAT, San Francisco, CA (US); Andrew Alan JOHNSON, Minneapolis, MN (US)

(73) Assignee: Roblox Corporation, San Mateo, CA (US)

(21) Appl. No.: 18/660,503

(22) Filed: May 10, 2024

Related U.S. Application Data
(60) Provisional application No. 63/465,621, filed on May 11, 2023.

(51) Int. Cl. G06T 19/20; G06T 13/40; G06T 17/20

(52) U.S. Cl. CPC G06T 19/20; G06T 13/40; G06T 17/205; G06T 2219/2021; G06T 2219/2024

(57) ABSTRACT

Some implementations relate to methods, systems, and computer-readable media to create a variant of a template avatar. In some implementations, the method includes obtaining a template avatar that includes a template geometry obtained from a mesh of the template avatar, generating a template cage associated with the template avatar as a low-resolution approximation wrapped around the template geometry, creating a target cage from the template cage by modifying the template cage based on input from a user, and morphing the template geometry with the target cage to generate a target avatar that is a variant of the template avatar. The method may also include adjusting a rigging and a skinning of the target avatar to enable animation for the target avatar. Using these techniques makes it more efficient and less labor-intensive to create a variant of a template avatar.

### CROSS-REFERENCE TO RELATED APPLICATIONS

This application claims priority to U.S. Provisional Application No. 63/465,621, entitled “CREATION OF VARIANTS OF AN ANIMATED AVATAR MODEL USING LOW-RESOLUTION CAGES,” filed on May 11, 2023, the content of which is incorporated herein in its entirety.

### TECHNICAL FIELD

Implementations relate generally to computer graphics, and more particularly but not exclusively, relate to methods, systems, and computer readable media to create and animate variants of a template avatar.

### BACKGROUND

Creating visually compelling animated avatars is a time-consuming process that involves a high level of expertise in three-dimensional (3D) modeling, character rigging, and animation. It can be difficult to enable user generated content (UGC) or to support developers with minimal 3D character creation experience, in the context of building 3D animatable avatars.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations of this application relate to creating high-quality variants of avatars. For example, a variety of techniques are used to create high-quality avatars while minimizing human labor. These techniques include obtaining information about a template avatar including a template geometry, generating a template cage that approximates the template avatar, creating a target cage from the template cage based on user input, and morphing the template geometry with the target cage to generate a target avatar.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to create a variant of a template avatar is provided, comprising: obtaining a template avatar that includes a template geometry obtained from a mesh of the template avatar; generating a template cage associated with the template avatar as a low-resolution approximation wrapped around the template geometry; creating a target cage from the template cage by modifying the template cage based on input from a user; and morphing the template geometry with the target cage to generate a target avatar that is a variant of the template avatar.

Various implementations of the computer-implemented method are described herein.

In some implementations, the computer-implemented method further comprises adjusting a rigging and a skinning of the target avatar to enable animation for the target avatar.

In some implementations, the template avatar further includes a template head of the template avatar, wherein the target avatar comprises a target head of the target avatar, and adjusting the rigging and skinning includes one or more of: determining a pose of the target head based on a particular pose of the template head; and determining a facial expression of the target head based on a particular facial expression of the template head.

In some implementations, adjusting the rigging and the skinning of the target avatar comprises: converting the mesh of the template avatar into a flat panel mesh; deforming the flat panel mesh into a deformed neutral based on neutral poses of the target avatar; performing retargeting on the deformed neutral to obtain a deformed rig of the template avatar; stitching the deformed rig onto a shape of the target avatar to generate a stitched rig having rigging and skinning; and after the stitching, performing skin diffusion on the stitched rig to obtain the target avatar.

In some implementations, the computer-implemented method further comprises: defining a space deformation function that maps a point in 3D world coordinates of the flat panel mesh to a 3D point in the deformed neutral; and using the space deformation function to deform the flat panel mesh into the deformed neutral.

In some implementations, the template avatar is associated with a plurality of poses encoded via facial action coding system (FACS) and performing retargeting comprises: performing a shape solve operation using the space deformation function to map a respective pose of the plurality of poses to generate a set of deformed pose shapes; and performing a joint solve operation comprising using the deformed neutral and the set of deformed pose shapes to serve as groundtruth shapes to construct a linear blend skinned rig for the target avatar.

In some implementations, morphing the template geometry of the template avatar with the target cage to generate the target avatar comprises using at least one surface-based deformation technique.

In some implementations, the using at least one surface-based deformation technique comprises performing wrap deformation to provide a wrap deformed version of the template avatar and selecting a sparse subset of deltas based on the wrap deformed version of the template avatar.

In some implementations, the at least one surface-based deformation technique comprises variational optimization.

In some implementations, the variational optimization includes radial basis function optimization to find a displacement field and applies the displacement field to the template avatar to generate the target avatar.

In some implementations, the computer-implemented method further comprises performing at least one of implicit surface tracking or Laplacian fitting.

In some implementations, performing the implicit surface tracking comprises: generating a first implicit surface based on the template cage; adding embedded isovalues of vertices of the template avatar to the first implicit surface; generating a second implicit surface based on the target cage; and projecting vertices of the target avatar towards corresponding isovalues in the second implicit surface based on the first implicit surface and the embedded isovalues of the first implicit surface.

In some implementations, the Laplacian fitting comprises solving a Poisson problem to reconstruct the target avatar based on a modified Laplacian designed to reproduce regular geometric shapes of the target cage by producing a surface for the target avatar that satisfies delta fit constraints.

According to another aspect, a non-transitory computer-readable medium is provided. The non-transitory computer-readable medium with instructions stored thereon that, responsive to execution by a processing device, causes the processing device to perform operations comprising: obtaining a template avatar that includes a template geometry obtained from a mesh of the template avatar; generating a template cage associated with the template avatar as a low-resolution approximation wrapped around the template geometry; creating a target cage from the template cage by modifying the template cage based on input from a user; and morphing the template geometry with the target cage to generate a target avatar that is a variant of the template avatar.

Various implementations of the non-transitory computer-readable medium are described herein.

In some implementations, the operations further comprise adjusting a rigging and a skinning of the target avatar to enable animation for the target avatar.

In some implementations, adjusting the rigging and the skinning of the target avatar comprises: converting the mesh of the template avatar into a flat panel mesh; deforming the flat panel mesh into a deformed neutral based on neutral poses of the target avatar; performing retargeting on the deformed neutral to obtain a deformed rig of the template avatar; stitching the deformed rig onto a shape of the target avatar to generate a stitched rig having rigging and skinning; and after the stitching, performing skin diffusion on the stitched rig to obtain the target avatar.

In some implementations, morphing the template geometry of the template avatar with the target cage to generate the target avatar comprises using at least one surface-based deformation technique.

According to another aspect, a system is disclosed, comprising: a memory with instructions stored thereon; and a processing device, coupled to the memory, the processing device configured to access the memory, wherein the instructions when executed by the processing device cause the processing device to perform operations including: obtaining a template avatar that includes a template geometry obtained from a mesh of the template avatar; generating a template cage associated with the template avatar as a low-resolution approximation wrapped around the template geometry; creating a target cage from the template cage by modifying the template cage based on input from a user; and morphing the template geometry with the target cage to generate a target avatar that is a variant of the template avatar.

Various implementations of the system are described herein.

In some implementations, the operations further comprise adjusting a rigging and a skinning of the target avatar to enable animation for the target avatar.

In some implementations, adjusting the rigging and the skinning of the target avatar comprises: converting the mesh of the template avatar into a flat panel mesh; deforming the flat panel mesh into a deformed neutral based on neutral poses of the target avatar; performing retargeting on the deformed neutral to obtain a deformed rig of the template avatar; stitching the deformed rig onto a shape of the target avatar to generate a stitched rig having rigging and skinning; and after the stitching, performing skin diffusion on the stitched rig to obtain the target avatar.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture to create and animate variants of a template avatar, in accordance with some implementations.

FIG. 2 is a flowchart of an example method to create and animate variants of a template avatar, in accordance with some implementations.

FIG. 3 is a flowchart of an example method to adjust a rigging and a skinning of a target avatar, in accordance with some implementations.

FIG. 4 illustrates an example of a workflow to create head cages and resulting animatable head variants, in accordance with some implementations.

FIG. 5 illustrates an example of a flat panel mesh and a rig, in accordance with some implementations.

FIG. 6 illustrates an example of an automated processing pipeline to deform the geometry of a flat face panel, in accordance with some implementations.

FIG. 7 illustrates further details of the automated processing pipeline, in accordance with some implementations.

FIG. 8 illustrates still further details of the automated processing pipeline, in accordance with some implementations.

FIG. 9 illustrates an example of shape transfer by leveraging existing dynamic heads, in accordance with some implementations.

FIG. 10 illustrates an example of a two-step approach including shape transfer and a linear blend skinning (LBS) rig solve, in accordance with some implementations.

FIG. 11 illustrates an example function that performs shape transfer via space deformation, in accordance with some implementations.

FIG. 12 illustrates rig transfer technology that, given correspondence between neutral expressions, automatically transfers rig and skinning and poses to a target, in accordance with some implementations.

FIG. 13 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure is directed towards, inter alia, techniques to deform a “template” avatar (or “avatar rigs”) to a target shape, and to automatically transfer the complex rigging elements of the template avatar to the target shape. The present disclosure provides ways to adapt an existing avatar rig to generate a new variant. This adaptation may be achieved with an intuitive workflow that deforms a pre-existing “template” avatar rig to a target shape and automatically transfers the complex rigging elements to the target avatar.

Implementations use low-resolution cages wrapped around the geometry of the template avatar to infer surface correspondences and to establish deformation fields between existing template avatar rigs and new target variants of the template avatar rigs. To create a new avatar variant, the proposed workflow includes two stages. Stage one may be a manual stage. For example, in a manual stage, a creator may create and/or sculpt the cages (e.g., through some digital content creation (DCC) tool or procedurally via scripting) to define the new coarse shape of the part. This is the only manual step to be done by the creator, which involves substantially less expertise than other approaches.

Stage two may be an automated stage. For example, in an automated stage, automated techniques may morph the underlying geometry and transfer the facial expressions. Implementations may additionally adapt joints and skinning to create a target facial rig that is optimized for run-time performance on mobile devices.

Automation brings down the time it takes to create the character rig and poses from a long period of time (such as about a month) down to a much shorter period of time (such as seconds). There may be a workflow of morphing the head part via a sculpting of the cage, which generates head identities that are automatically posed with facial expressions. In such a workflow, users sculpt an existing cage to a shape the users want. Then, automated techniques morph the original geometry to a morphed target, along with adapting the joints and skinning.

Once the user has sculpted the cages to the intended shape, the following main steps of automated techniques run to create the animated avatar variant. In a cage morphing process, this technique morphs the underlying avatar part such that its coarse shape matches the change in shape of the cage. Multiple approaches have been considered. For example, the approaches include space deformation via radial basis functions (RBF), wrap deformation, and surface deformation. In some implementations, surface deformation may provide an effective way to create the animated avatar variant.

The present formulation of surface deformation includes three terms in an optimization framework. These include variational optimization, implicit surface tracking, and Laplacian fitting. Variational optimization imposes physical constraints to ensure plausible results. Implicit surface tracking extends an implicit skinning technique to surface-based deformations. Laplacian fitting may be a variation of a Laplacian surface editing technique used to reproduce regular geometric primitive properties.

The cage morphing may be followed by a pose/expression transfer. This technique adjusts the joints and skinning to adapt the facial expressions and poses of the initial geometry into plausible expressions/poses for the cage-morphed geometry. A feature is the use of a space deformer (e.g., a radial basis function (RBF)) computed from the cage morphing step to compute the target geometry vertices for each facial expression and body pose.

The pose/expression transfer may be followed by a rig creation. For a linear blend skinning (LBS) rig, it may be possible to use the computer target vertices from pose/expression transfers as constraints to a known solver to adjust the joint transforms and skinning. For blendshape rigs, implementations may compute the vertex deltas for each pose/expression.

There may be examples of an animated avatar rig and its corresponding cages, in accordance with some implementations. Specifically, and as illustrated in the examples, the avatar rig may be an animatable/animated template avatar illustrated by a mesh. Multiple low-resolution cages are created and wrapped around parts (e.g., head, torso, hands, feet, etc.) of the avatar rig. Cages in other contexts may be used for wrapping clothing and facial accessories around avatars, and the implementations disclosed herein use the cages to generate new variants of a template avatar.

One aspect of examples may include a pose/expression transfer technique. The technique adjusts the joints and skinning to adapt the facial expressions and poses of the initial geometry (e.g., the geometry of a head) to plausible expressions/poses for the cage-morphed geometry (e.g., the geometry of head variants). An aspect of this technique is the use of a space deformer (e.g., an RBF), computed from the cage morphing step, to compute the target geometry vertices for each facial expression and body pose.

Another aspect may be rig creation. For a linear blend skinning (LBS) rig, automated techniques may use the computed target vertices from the pose/expression transfer as constraints to a known solver to adjust the joint transforms and skinning. For blendshape rigs, the automated techniques can compute the vertex deltas for each pose/expression. Further details of pose/expression transfer (e.g., shape solving) and rig creation (e.g., LBS rig solving) according to various implementations are provided herein.

According to various implementations, a platform is provided wherein each user may have an expressive and communicative avatar. The platform may have a large variety of avatars with static (e.g., non-animatable) heads that the user community uses to represent themselves in virtual experiences.

The ability of one or more avatars to exhibit animatable facial expressions on a media platform poses a challenge to convert one or more of the static heads of the one or more avatars into versions that support high-quality facial expressions. This introduces a scalability challenge as the one or more static heads are generally constructed as a combination of a static decal and a simple head shape mesh. Face, mouth, eyes, and other facial features of the avatars are not generally represented with geometry, and hence, are not easily animated. An example media platform may have approximately 600 static decals with approximately 50 head shapes. Such an example equates to the possibility of 30,000 different heads that may be made animatable. Decoupling of a static head into a decal and a head shape allows decoupling the rigged, skinned, and animated face from the head shape. Artists (and other creators) may generate a rigged and animatable face on a flat panel mesh, effectively simplifying the creation of the geometry, rig, and animations, closer to a two-dimensional (2D) problem. With implementations of an automated face stitching technique described herein, a pipeline may then morph and stitch these artist-generated flat face panels onto any head shape. This morphing and stitching enable a generation of combinations of animated faces and head shapes at scale.

The implementations may provide a workflow to convert one or more avatars with static heads into avatars having animatable facial expressions. There may be example static heads on the media platform, in accordance with some implementations. A variety of head shapes and static decals may be provided.

Each specific static head may be the result of texturing a chosen head shape (e.g., one of roughly fifty shapes available) that has a defined UV mapping with a static face decal (e.g., roughly six hundred decals are available), live during runtime. By decoupling the head shape from the static decal, the number of unique heads scales combinatorically, resulting in a larger variety of static-head avatars for users to choose.

Manually converting a static head into one with animatable facial expressions may be a time consuming process. Such manual conversion may include modeling a geometry with animatable parts to look like a static face decal, creating a joint rig, skinning the vertices, and finally, posing the geometry into facial expressions. Doing manual conversion individually for every combination of head shape and face decal in a catalog of avatars/heads is unscalable. Accordingly, the implementations disclosed herein take a combinatorial approach, decoupling the animatable face rig creation from the final head shape.

Using an automated processing pipeline to stitch an animatable face and its rig to a head shape mesh, the creation of the animatable face mesh and rig may be simplified to being primarily a flat square face surface. For example, some implementations may use an example of a flat panel face mesh and rig. There may be a front view, a side view, joints of the rig, and facial action coding system (FACS) poses that when blended together, create facial expressions. Although a few FACS poses (for example, six poses) may be used in one example, a much larger number (such as anywhere between eighty-five to one hundred twenty poses) (again, as an example) may be defined for use in a rig-retargeting solver.

Using the technique discussed herein, the curvature of any particular head shape does not have to be handled during rigging and animation. These flat panel face rigs may be two-and-a-half-dimensional (2.5D) as there is some depth for the mouth bag shape and the teeth/tongue parts inside as well as off-surface components for eye parts and other facial features. The animation used for the eyes, brows, and nose of the face may be primarily 2D. This less complex approach greatly simplifies the process of rigging, skinning, and animating. By design, the main surface of the flat panel face mesh and rigs may be squares so that the xy-coordinates of the vertices are exactly the uv-coordinates in UV space.

With the flat panel face mesh and rig created, next is an automated method to stitch the flat panel face rigs to the existing head shapes. An automated processing pipeline stitches the flat panel face mesh and rigs onto the head shape meshes as defined by the UV mapping, similar to how an actual texture is applied to a mesh. Given a flat face panel mesh and a target head shape, the automated pipeline generates a fully rigged and animatable stitched head.

In some implementations, an automated processing pipeline deforms the geometry of a flat face panel. The flat face panel is retargeted onto a head shape with obtained UV mapping to result in a fully rigged and animated stitched head with facial expressions.

Some technical challenges for this processing pipeline require techniques to address and these techniques may include the following. Flat panels are deformed onto the arbitrarily shaped surface of a head shape mesh. If the flat panels were very thin, this is a straightforward mapping via UV coordinates and signed normal distance from the face's surface. However, the flat panels are 2.5D flat panels. Also, the flat panels may have an inner mouth bag with teeth and tongue parts. It presents a challenge to determine how these parts deform when the face surface is stitched onto a curved surface.

The rig of the flat face panel rig is to be retargeted, so that the resulting facial expressions on the stitched head look good. Because it is helpful to be able to stitch the flat face panels to any arbitrary head shape, implementations may have a general methodology that can account for wide curvature differences and anisotropic scaling. This general methodology may permit use of a wide variety of head shapes.

In some implementations, a first part of the automated processing pipeline deforms the flat face panel in a neutral pose to the head shape, and then retargets the rig. Retargeting the flat face panel rig to the head shape may be done in two steps, specifically, a shape solve step and a joint solve step. A second part of the automated processing pipeline stitches the deformed face rig to the head shape to generate a stitched head rig. The automated processing pipeline may also apply some skin diffusion around the edges of where the deformed face rig is stitched to get a smooth fall off for deformation in the final result of the pipeline.

Example predominant weighting issues may include the following. One example is weight gaps. When the weights do not extend to the boundary evenly, weight can “bleed” around fixed weights on the interior, leading to undesirable deformations. The bottom corners of the panel may be weighted entirely to the head to “pin” these corners.

Keeping this results in a “pinned pool” of weights. Weight gaps may be corrected for by applying a narrow-band diffusion, centered on the stitch-boundary, and blending over a specified geodesic distance from the boundary, which may involve a designated “blending mask.” There may also be issues of interior overweighting. In some implementations, the mouth bag weights are often too high for head shapes that do not leave much room between the skin surface and the interior of the mouth, leading to crashing if the interior weights are not adjusted as part of the diffusion process.

Overweighting of the mouth bag may be corrected by diffusing limiting weights from the surface into the interior by means of scalar extension using a vector heat method on the point cloud of the mesh. This avoids the problems of “bleeding” by diffusing the weight in R³. Similarly, these new weights are then extended to the lower teeth and tongue, keeping their weights proportional to those of the surrounding mesh. For example, there may be a scalar extension of mouth bag with respect to tongue and lower teeth. There may also be overweighting that is corrected for.

There may be various examples of stitching results, in accordance with some implementations. For example, a variety of flat face panels may be stitched to one of a number of head shapes, and animation may be performed accordingly.

The implementations disclosed herein thus provide a method to stitch a rigged, skinned, and posed 2.5D flat panel onto a mesh surface. Such a method is analogous to rendering a texture on a mesh via a UV mapping. Fine tuning and consideration of many details in the specific set of flat face panels and head shapes achieves high quality results.

Consistent geometry may be maintained across all or almost all flat face panels. Specifically, enforcing similar signed distances of the 2.5D parts (e.g., eyes, brows, mouth bag, teeth, and tongue) improves the result quality. By enforcing these distances, it makes the results more predictable, resulting in less crashes in the final stitched assets.

In the deform neutral step, adding subdivision surface smoothing to the head shape when deforming the flat face panel helps create a higher quality stitching result. This approach removes faceting that was present on the original head shapes and reduces the associated artifacts in the final stitched asset. Defining vertices that do not move between the neutral pose and any particular FACS pose is important for creating good-looking and intuitive retargeting.

With respect to symmetry, apart from the usual issues of minor numerical asymmetries, and intentional asymmetric designs, unintended asymmetries that are introduced during both the shape solve and joint solve are managed by implementations. Asymmetries introduced by the joint solve (e.g., joint rest pose/vertex weights) are generally attributable to asymmetries in the input from the shape solve. However, as these asymmetries may include intended design asymmetries, correcting the shape solve output may not be enough to guarantee symmetric joint solve results. Similar re-establishment of intended symmetries is thus applied post-solution.

Skin diffusion, and particularly the subsequent normalization (including clipping small weights and limiting the number of joints/vertex) may cause small asymmetries to be amplified by the process. Ensuring that the results of both solve operations (i.e., shape solve and joint solve) are symmetric where the results are intended to be symmetric reduces the issue of amplified asymmetries. However, weights still have to be symmetrized after diffusion to ensure proper results.

With respect to smoothing, the method of diffusing weights may use a graph Laplacian. While this method may be quite fast, the results are dependent on the topology of the mesh alone. Using a cotangent Laplacian deals with the topology issue but leaves continuity issues. Solving a biharmonic equation with the cotangent Laplacian corrects for the previous issues. Rather than minimizing the Laplacian energy (E_{Δ}²), the method can get better “shaped” results by minimizing the Hessian energy (E_{H}²).

Debugging may be helpful for decoupling the steps of finding the shapes via shape solve versus the final linear blend skinned rig via joint solve. Being able to visualize each individual step of the process in producing the final stitched result permits implementations to narrow down which step in the process was failing or providing unacceptable results.

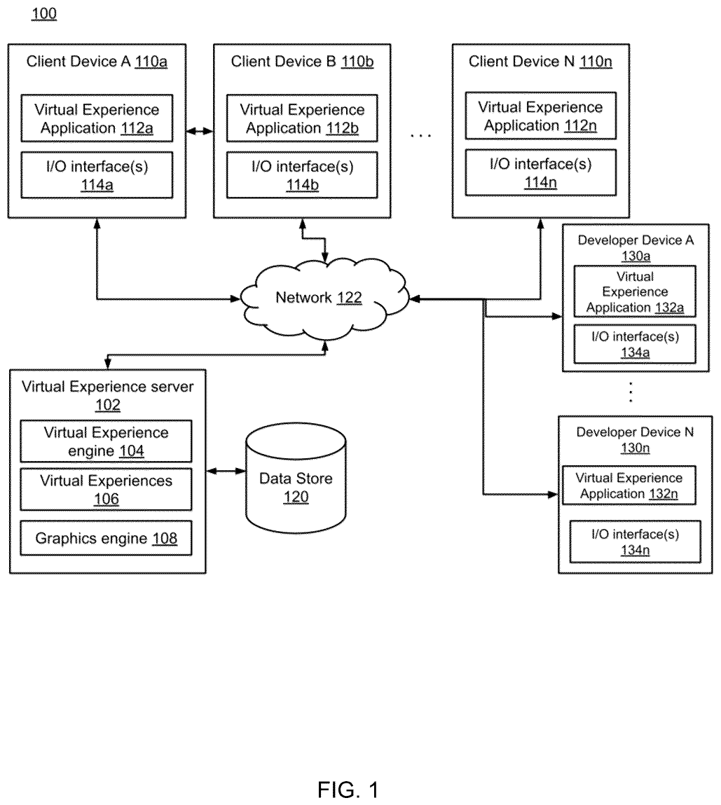

### FIG. 1—System Architecture

FIG. 1 is a diagram of an example system architecture to create and animate variants of a template avatar, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

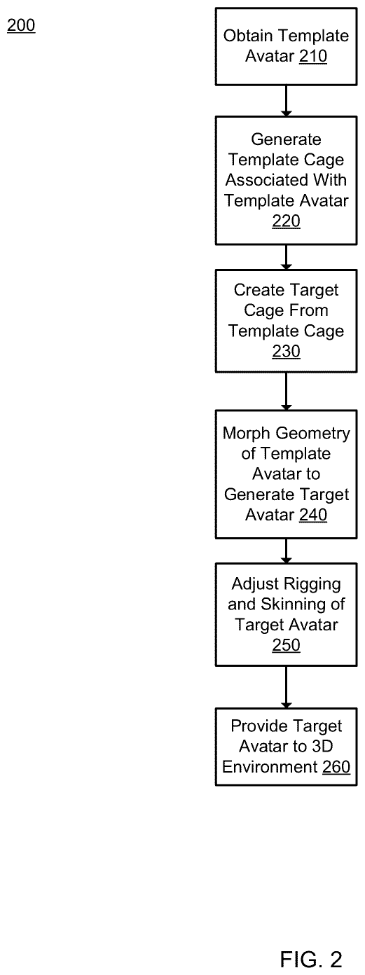

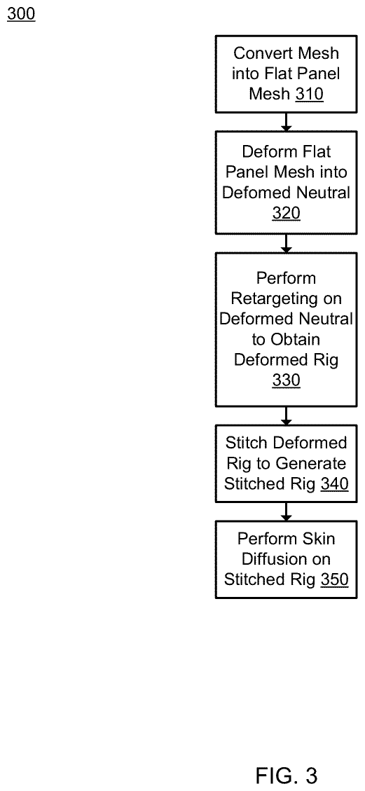

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowcharts shown in FIGS. 2 and 3. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online gaming server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the client device(s) 130 by the online virtual experience server 102. In another example, the virtual experience application 132 may be an application that is downloaded from a server. Game application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

### FIG. 2—Creating and Animating Variants of a Template Avatar

FIG. 2 is a flowchart of an example method to create and animate variants of a template avatar 200, in accordance with some implementations. The method 200 may begin at block 210.

At block 210, a template avatar including a template geometry is obtained. For example, the template geometry may be obtained from a mesh of the template avatar. Information about the template avatar may be obtained from a virtual experience within a virtual environment. Block 210 may be followed by block 220.

At block 220, a template cage associated with the template avatar is generated. The template cage may be generated by wrapping a cage around the template geometry. The template cage may be a low-resolution cage (where the cage has a lower resolution than the template geometry). The template cage may offer a way to infer surface correspondences and establish deformation fields between existing template rigs and new target variants. Block 220 may be followed by block 230.

At block 230, a target cage may be created from the template cage based on input from a user. For example, the user sculpts the template cage (e.g., through some digital content creation (DCC) tool or procedurally via scripting). This cage creation is the only manual part of the process. Block 230 may be followed by block 240.

At block 240, geometry of the template avatar may be morphed with the target cage to generate a target avatar. Automated techniques morph the underlying geometry and transfer the facial expressions. The morphing works by morphing underlying avatar parts such that their coarse shape matches the change in shape of the cage. Several approaches exist, including space deformation via radial basis functions (RBFs) or wrap deformation.

However, another technique may include surface deformation, which may include an optimization framework involving variational optimization, implicit surface tracking, and Laplacian fitting. Variational optimization imposes physical constraints to ensure plausible results. Implicit surface tracking is a technique that extends an implicit skinning technique to surface-based deformations. Laplacian fitting is a variation of a Laplacian surface editing technique used to reproduce regular geometric primitive properties. Additional details about the morphing are discussed herein. Block 240 may be followed by block 250.

At block 250, a rigging and a skinning of the target avatar may be adjusted. This operation may include a pose/expression transfer. The adjusting of the rigging and the skinning adjusts the joints and skinning to adapt the facial expressions and poses of the initial geometry into plausible expressions/poses for the cage-morphed geometry.

A feature may be the use of a space deformation (e.g., an RBF), computed from the cage morphing step, to compute the target geometry vertices for each facial expression and body pose. For a linear blend skinning rig, it is possible to use the computed target vertices from pose/expression transfer as constraints to a known solver to adjust the joint transforms and skinning. For blendshape rigs, implementations may compute vertex deltas for each pose/expression. Block 250 may be followed by block 260.

At block 260, the target avatar may be provided to a three-dimensional (3D) environment (such as a virtual gaming environment). For example, the information about the generated mesh may be provided to the 3D environment for avatar rendering, avatar animation, or for other applications. Block 260 may be followed by the 3D environment making use of the information about the target avatar to display or animate the target avatar.

### FIG. 3—Adjusting Rigging and Skinning of a Target Avatar

FIG. 3 is a flowchart of an example method to adjust a rigging and a skinning of a target avatar 300, in accordance with some implementations. Method 300 may begin at block 310. Method 300 may correspond to block 250 of FIG. 2 and provides greater details about how a rigging and a skinning of a target avatar may be performed.

At block 310, a mesh may be converted into a flat panel mesh. The conversion may include using an automated processing pipeline to stitch an animatable face and the rig of the animatable face to a head shape mesh. The creation of the animatable face mesh and rig may be simplified to being primarily a flat square face surface, which may include multiple views. Using this technique, the curvature of any particular head shape need not be handled during rigging and animation. These flat panel face rigs may be two-and-a-half dimensional (2.5D) as there is some depth for the mouth bag and the teeth/tongue parts inside as well as off-surface components for eye-parts and other facial features. Block 310 may be followed by block 320.

At block 320, the flat panel mesh may be deformed into a deformed neutral. This operation takes a head shape and a flat face panel rig in a neutral pose and performs UV mapping resulting in a deformed neutral. Hence, at block 320, the first part of the automated processing pipeline deforms a flat face panel in a neural pose to the head shape and then retargets the rig. Such a deformed neutral may be a generic model of a head, having no rig, no skinning, and no poses. Block 320 may be followed by block 330.

At block 330, retargeting may be performed on the deformed neutral to obtain a deformed rig. For example, retargeting may include performing a shape solve on the deformed neutral rig. Such a shape solve may involve using facial action coding system (FACS) poses via UV mapping, where UV mapping is the 3D modeling process of projecting a 3D model's surface to a 2D image to perform texture mapping. The result of the shape solve may be deformed pose shapes with no rig and no skinning. The flat face panel rig may also provide a joint hierarchy and initial skinning weights.

The shape solve may be followed by a joint solve. The joint solve takes the deformed pose shapes (with no rig and no skinning) along with the joint hierarchy and initial skinning weights. The joint solve joint transforms and skins weights via Smooth Skinning Decomposition with Rigid Bones (SSDR). The deformed neutral and each pose shape serve as the groundtruth shapes to optimize the joint transforms for every pose and vertex skinning weights in order to construct a linear blend skinned rig. A result of the joint solve may be a deformed face rig. Block 330 may be followed by block 340.

At block 340, the deformed rig may be stitched to generate a stitched rig. A head shape and a deformed face rig are stitched into a stitched head having rigging and skinning. There may be zero skinning weights on non-panel parts of the head. Block 340 may be followed by block 350.

At block 350, skin diffusion may be performed on the stitched rig. Such skin diffusion may result in a final resulting head. The final resulting head may be a stitched head having rigging and skinning. The automated processing pipeline may apply some skin diffusion around the edges of where the deformed face rig was stitched to get a smooth fall off for deformation. After block 350, the target avatar is ready and may be provided for use in block 260.

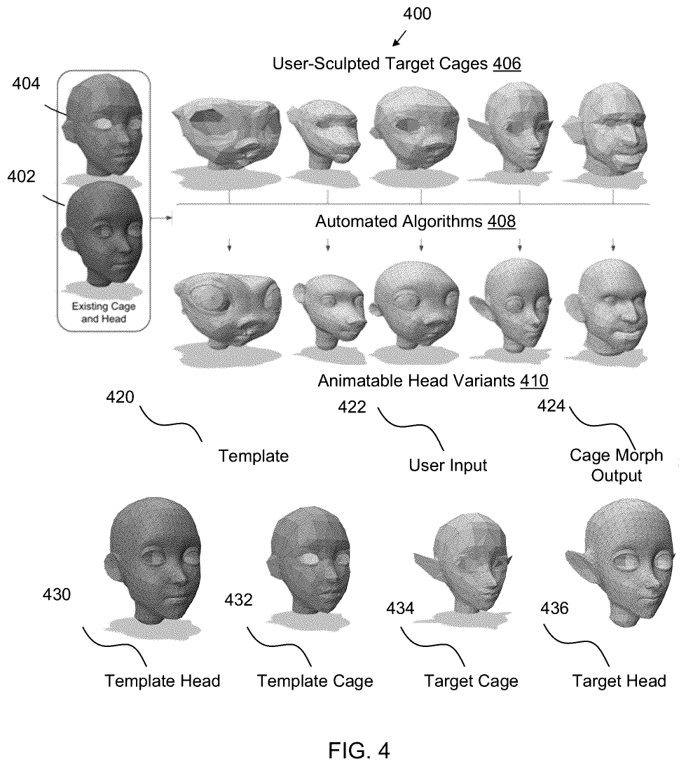

### FIG. 4—Workflow to Create Head Cages and Resulting Animatable Head Variants

FIG. 4 illustrates an example of a workflow to create head cages and resulting animatable head variants 400, in accordance with some implementations. While the workflow of FIG. 4 is adapted for use with avatar heads, it may be recognized that some implementations use similar techniques for other parts of avatars. For example, there may be an existing template head 402 and an existing template cage 404, used as a template for a new avatar, in particular a head of a new avatar.

FIG. 4 illustrates several examples of user-sculpted target cages 406. For example, sculpted target cages 406 illustrate a number of cages corresponding to avatar heads, where facial shapes and portions of the faces (such as eyes, mouths, noses, ears) have varying sizes and shapes. The sculpting may use a DCC tool or a language to perform sculpting. FIG. 4 illustrates that each of the user-sculpted target cages 406 is fed as input to automated algorithms 408.

The automated algorithms 408 generate corresponding animatable head variants 410. Such animatable head variants 410 have similar shapes to the user-sculpted target cages 406. The animatable head variants 410 have greater detail by identifying related information from existing template head 402 and incorporating the information into the animatable head variants 410.

As a related example, also illustrated in FIG. 4 is a sequence that helps communicate how some implementations operate. For example, FIG. 4 illustrates that there may be a template 420, user input 422, and cage morph output 424. The template 420 may include, for example, a template head 430 (corresponding to existing template head 402) and a template cage 432 (corresponding to existing template cage 404). The user input 422 may include a target cage 434. The cage morph output 424 may include a target head 436.

Specifically, an animatable existing template head 402 may be graphically represented by a mesh, and a low-resolution existing template cage 404 may be created/sculpted or otherwise provided for the existing template head 402, such as by wrapping over the mesh of the existing template head 402.

Implementations of the workflow 400 may include at least two steps. As a first step, a user may sculpt the first existing template cage 404 into one or more target cages 406. In this first step, the user may sculpt (e.g., create) these target cages 406 using any suitable graphical tool, procedurally via scripting, or using another approach, so as to define the new coarse shape of the part (e.g., one of the low-resolution target cages 406 for the existing template head 402). This first step may involve substantially less expertise for the user/creator and may therefore be user-friendly and easy to do.

As a second step, one or more automated algorithms 408 morphs the original geometry of the existing template head 402 into a morphed target, so as to result in one or more head variants 410, along with adapting the joints and skinning. The second step results in an animatable head having parts (e.g., mouth, lips, eyes, etc.) that move correctly when animated.

For example, in the second step, the automated algorithms 408 morph the underlying geometry of the existing template head 402 and transfer the facial expressions of the existing template head 402. The automated algorithms 408 additionally adapt the joints and skinning to create a target facial rig that is optimized for run-time performance on mobile devices.

Automation using the automated algorithms 408 in this manner may reduce the time it takes to create the character rig and poses from about a month down to seconds. In FIG. 4, the workflow 400 morphs the existing template head 402 via a sculpting of the existing template cage 404, which generates visually varying head identities (e.g., the head variants 410) that may be automatically posed with facial expressions.

Further details are provided for various implementations of the second step, which includes the automated algorithms 408 that transform the user-sculpted target cages 406 into animatable head variants 410.

Once the user has sculpted the target cages 406 to their intended shape (e.g., during the first step described above), the following operations of the automated algorithms 408 may be executed on the target cages 406 to create the animated avatar variant(s).

The automated algorithms 408 may include a cage morph or cage morphing technique. This technique morphs the underlying avatar part (e.g., the existing template head 402) such that the coarse shape of that avatar part matches the change in shape provided by the target cage 406. Multiple approaches are possible. For example, possible approaches include space deformation using a radial basis function (RBF), wrap deformation, or surface deformation. According to various implementations, the automated algorithms 408 use surface deformation to perform cage morphing. Three aspects of cage morphing may be involved in some implementations, such as variational optimization, implicit surface tracking, and Laplacian fitting.

Variational optimization is an approach that imposes physical constraints to ensure plausible results. Implicit surface tracking is a technique that extends implicit skinning techniques to surface-based deformations. Laplacian fitting is a variation of Laplacian surface editing techniques used to reproduce regular geometric primitive properties. Additional details about these various approaches and their use in cage morphing are presented, below. A result of this cage morphing step is generating a new target head for a next step in the process, pose/expression transfer, which uses this mesh (from the cage morphing step) to fit a dynamic head rig onto.

The process begins with one of several pre-defined templates that contains a template head (the mesh that is rendered), a template cage (a low-resolution approximation of the template head), skinning (joints and weights for the template head) and facial action coding system (FACS) shapes (animation poses of the joints representing distinct facial expressions/phonemes). The result of the entire process is to adapt this known good template to a fully functional dynamic head rig that matches modifications specified by the user.

The way the user specifies the modifications the user wants to make to the template head is by providing a deformed version of the template cage called the target cage. In this way, the user never has to directly modify the far more complex template head or its skinning. The user also does not have to update the associated joint poses for the FACS shapes.

Likewise, there is a known high quality dynamic head rig to start with (the template head rig). Implementations may constrain the modifications to the template head rig to a feasible range of possibilities. Such a constraint may help provide that the result is a working dynamic head rig.

Conceptually, a result of the cage morphing step is to apply a deformation to the template head mesh that is similar to the deformation resulting from taking the template cage to the target cage. A way to view the problem is as a so-called space deformation. In this view, the problem is modeled by imagining some function that deforms space such that the points that were located at the vertices of the template cage are now transformed to the points located at the corresponding target cage vertices. This deformation function also smoothly deforms the space in between each of these points.

In this manner, the deformation function similarly deforms the points located at the template head vertices to new points which define the target head shape. There are many ways to define such a space deformation function. A straightforward approach to such a space deformation function is by means of radial basis function (RBF) interpolation.

Another common method to perform space deformation is by means of generalized barycentric coordinates (most commonly mean value coordinates and harmonic coordinates). This method is not exactly the same as a globally supported space deformation but has many similarities to a globally supported space deformation. A difficulty with these approaches is the demands the approaches place on the shapes defining the domain of the space (e.g., requiring closed meshes, usually convex). There are also computational and numerical challenges involved in these methods.

Another approach to addressing these problems is to “bind” the template head vertices to the surface of the template cage. When the template cage is deformed into the target cage (by simple linear shape interpolation), the vertices of the template mesh accompany the deformation and maintain their relative offset from the cage surface. This approach may be very effective, and a variation of wrap deformation may be used as a part of the surface-based deformation used in implementations.

A first aspect of wrap deformation is that the template head has to have an appropriate surface point on the template cage to bind to. In some implementations, cages are not closed surfaces. The cages contain holes around the eyes, mouth and neck. The template head is a closed mesh and does contain geometry in those regions. The only surface points such regions can bind to on the template cage are at the geometric boundaries of the holes. This situation results in a less-than-ideal binding for several reasons including a non-normal offset vector and sensitivity to twisting of the local coordinate frame. One solution is to fill the holes in the cage, but this leads to a second limitation.

Such a second limitation is that the normal depth of the offset from the template head to the template cage is a challenge in some areas of the shape. The closer the template head vertices are to the surface of the template cage, the more meaningful the binding to the surface becomes. As the position of the template head vertices increases in normal distance from the template cage, it becomes less clear which point on the surface of the template cage is to be bound to. Also, the less relevance the deformation of the template cage surface is to the position of the bound template head vertex. For example, it may be an issue to which point on the surface of the template cage a vertex in the back of the mouth is to be bound to.

Another issue faced with using wrap deformation without modification, is that such a technique involves binding the template mesh to whatever target cage shape the user provides, no matter how infeasible or inappropriate that shape is for the rig transfer stage. Implementations benefit from being able to limit how extensive the deformation to the template mesh in order to have any chance at finding a solution at the rig transfer operation. There is nothing inherent in standard wrap deformation that may provide that feature of deformation limiting. Generally, the techniques presented herein are used for situations in which the template and target meshes are of similar resolution.

Surface-based deformations, also called “shape aware” deformations, are deformations that take into account the intrinsic differential geometric properties of the mesh to generate deformations that minimize the local distortion of the shape. Some implementations use such deformations. This technique allows the implementations to achieve results that are both physically plausible and constrained to a feasible range of shapes that can be solved for in the pose/expression transfer process.

A preliminary step in the surface-based deformation starts with a variation of wrap deformation. Rather than averaging local coordinate frames to bind to on the template cage, some implementations instead bind directly to a frame obtained from the closest triangle in a loop subdivision of the template cage.

In order to ensure this subdivision surface is free from geometric artifacts such as creases, some implementations first optimize the topology of the cage by performing a greedy edge-flip optimization that maximizes the minimum corner angles of the triangles and preserves feature edges. A similar process is performed on the target cage and the bindings to the template cage subdivision are transferred to the target gage subdivision. Evaluation of those bindings on the target cage subdivision yields a wrap-deformed version of the template head.

From that wrap-deformed template head, some implementations select a sparse subset of deltas (displacement vectors between corresponding vertex positions) based on certain criteria aimed at evenly distributing the selection and emphasizing parts of the mesh that characterize the features of the shape. For example, delta selection may be based on cage points, curvature points, and UV boundary points. In this way some implementations use the wrap deformation as a guide to the surface-based deformation. Some implementations take steps to match the deformation defined by the wrap deformation, but only to the extent that implementations can preserve the intrinsic geometric properties of the original template head shape.

Based on the techniques discussed above, the selection of deltas does not include any vertices that are considered to have low-quality bindings in the wrap deformer. These vertices are those that coincide with a hole in the template cage or have an offset in the normal direction that is too large to be considered reliable (e.g., interior of the mouth or eye sockets).

The Euler-Lagrange equation −kₛΔd+k_{b}Δ²d=0 (Equation 1) minimizing the thin-shell energy is represented by the linear system A=−kₛL+k_{b}(LM⁻¹L) (Equation 2). Adding the weighted delta constraints, which are soft-constraints to partial differential equations (PDE), given

$$\tilde{A} = [ \begin{matrix}A \\ {ω}_{m + c , n}\end{matrix} ] \qquad ( Equation 3 )$$

$$and$$

$${\tilde{A}}^{T} \tilde{A} d = {\tilde{A}}^{T} [ \begin{matrix}0 \\ {ω}_{m + c} {δ}_{c}\end{matrix} ] \qquad ( Equation 4 )$$

and solving for displacements d for a solution displacement field in a least-squares sense yields the smooth displacement field defined over the entire manifold of the template head mesh that minimizes change in area and change in curvature. Such curvature corresponds to Dirichlet energy (also known as stretching) and Laplacian energy (also known as thin-plate or bending) respectively. Dirichlet energy penalizes stretching and is characterized by the Laplace equation. Laplacian energy penalizes bending and is characterized by the Bi-Laplace equation. This surface-based deformation method is a variational surface deformation technique known as thin-shell optimization (as a type of radial basis function optimization).

In these equations, the stretching and bending stiffness coefficients are represented by kₛ and k_{b} respectively. The Laplacian is represented by Δ and the bi-Laplacian by Δ² (L and LM⁻¹L in Equation 2). Thus, implementations are minimizing the stretching/bending with respect to the displacements (difference vectors between two positions) rather than minimizing those energies on the positions of the points. The former pertains to “smoothing” the deformation, while latter pertains to “smoothing” the surface itself (thus managing details). The displacements being solved for are represented by d, and the right-hand side with a value of 0 enforces the minimization of Equation 1. The system of equations is solved in a least-squares sense subject to weighted Dirichlet boundary conditions provided by the delta constraints (Equation 4).

As noted, none of the constraints includes deltas from regions such as the interior of the mouth. The solution to Equation 4 may include displacements for these regions that are consistent with the template head surface properties subject to the given constraints.

Applying the solved-for displacement field to the template head generates the target head mesh, such that a template mesh with solved displacements is used to generate the target head mesh. The target head then may have several properties. First, the target head is deformed in a manner consistent with the example deformation provided by the mapping from the template cage to the target cage. Second, the target head minimizes deformation energies such that the target head is everywhere locally similar to the template head (i.e., the target head preserves the features of the template head). Third, the target head does not contain any extensive deformations that may be present in the target cage example. Fourth, the target head represents a shape that may find a solution to fitting the template skinning/animation.

At this point, if the intent of the deformation described by the target cage is to define a re-shaping of the template mesh while retaining the surface features present in that mesh, the process is complete. However, if the user intended the target cage to define modeling of new surface features absent in the template mesh, the user may find the current results to be too restrictive. By design, the target mesh at this point likely has not maintained its local offset from the target cage as the target mesh may have done with a standard wrap deformation. Accordingly, modeling new features with the target cage is not generally possible. In order to capture some of these new modeling features, a further deformation step may be involved.

In order to recover some of the modeling features of the target cage that were lost in the surface-based deformation, techniques may expand upon the implicit skinning technique by tracking the template head mesh embedded in an implicit surface function defined by the template cage.

Implicit surfaces are shapes defined by a scalar field. Implicit surfaces exist at all points where the function (isovalues) is a constant value (most commonly zero). This set is referred to as the zero-level-set of the implicit function. All other points in space have a non-zero isovalue. The sign of an isovalue indicates whether such points having the non-zero isovalue are inside the surface, or outside of the surface. Often, a mesh reconstruction technique such as marching cubes or dual-contouring is employed to generate a mesh representing the zero-level-set.

The present implementations do not use this implicit surface in isolation. Rather, implementations focus on where vertices of template head are located relative to this level set. By recording the isovalues of the vertices of the template head in the implicit surface field of the template cage, implementations are effectively embedding the template head within this field. Implementations may likewise generate an implicit surface field from the target cage and project the vertices of the target head back towards their embedded isovalues using this target implicit surface.

Implicit surfaces have many helpful properties such as modeling self-contact, defining a continuous gradient at every point in space (not just on the surface of the implicit surface), and defining a smooth interface. However, there is no known direct way in which points embedded in an implicit surface function may be made to deform with deformations to the implicit field.

Other methods may be used to help the points move with the field. In certain techniques to perform implicit skinning, linear blend skinning (LBS) is used to provide this help or “tracking.” The tracked points are then projected along the implicit field's gradient back to their embedding isovalues. Some implementations adopt a variation of this technique. However, these implementations use the surface-based deformation mentioned herein to provide this tracking.

By using a surface-based tracking method, implementations are not simply replacing one pre-deformer with another. Instead, implementations gain additional deformation properties that implementations otherwise do not have by using a relatively arbitrary deformation technique such as linear blend skinning (LBS).

The surface-based deformation minimizes deformation energies, in particular stretching. The implicit surface projection is constrained to the gradient direction. Accordingly, implementations gain tangential skin sliding deformation that is both desirable and difficult to model with techniques such as LBS. In short, the surface-based tracking of the mesh provides a very high quality and effective starting point from which to begin projection back toward the embedding isovalues.

Additionally, the delta constraints used in the surface based deformation are directly related to the deformation of the template cage to the target cage and the implicit surface functions are directly related to the template cage and the target cages. Therefore, the tracking pre-deformation is directly correlated to the deformation of the implicit surface. This approach provides a far less arbitrary source of tracking within the field than in alternative approaches.

Implementations may obtain the implicit scalar field defining the implicit surface by sampling the template and target cage meshes (both position and normal), and fit a Hermite Radial Basis Function dᵢ(xᵢ)=Σₖ₌₁^{m}λₖφ(∥x−vₖ∥)+βₖ^{T}∇φ(∥x−vₖ∥) (Equation 5) to these samples such that its values are 0 at the sample points (i.e. on the surface) and its gradient is aligned with the normals of the surface at these samples as per Equation 5.

The final projection back to the embedding isovalues is achieved by using Newton iterations to step along the gradient of the implicit surface field of the target cage as per

$$\overline{{x}_{ι}} = {x}_{i} + σ ( f ( {x}_{i} ) - {iso}_{i} ) \frac{∇ f ( {x}_{i} )}{{‖ ∇ f ( {x}_{i} ) ‖}^{2}} . \qquad ( Equation 6 )$$

As this projection is a deformation away from the surface minimizing deformation energies, there is the potential that implementations may end up with a surface that is not feasible in the pose fitting stage. However, this is a post-processing operation and can be weighted by the user, and implementations may potentially enforce a cutoff weight when the pose fitting error crosses some acceptable threshold as per Equation 6.

A natural extension to this method is to combine the original tracking technique of LBS tracking with the surface-based approach implementations use. Rather than obtain the delta constraints to the thin-shell optimization (as a type of radial basis function optimization) from a wrap-like deformer, some implementations may instead take the delta constraints from a LBS deformation from a skeleton deforming the body. This approach provides the benefits of the skin sliding implementations obtained from the surface-based approach in the context of the more appropriate skeletal skinning deformation often used to deform character bodies.

Hence, the implicit surface tracking may include generating a first implicit surface based on the template cage, adding embedded isovalues of vertices of the template avatar to the first implicit surface, generating a second implicit surface based on the target cage, and projecting vertices of the target avatar towards corresponding isovalues in the second implicit surface based on the first implicit surface and the embedded isovalues. Alternatively put, the vertices are adjusted so that their isovalues agree in both the source and target implicit functions. Some implementations may use implicit functions in that some implementations may take values from anywhere in a 3D field, rather than merely contouring a uniform isovalue producing a level set.

Another condition that arises from the surface-based thin-shell optimization (as a type of radial basis function optimization) is that by minimizing bending energies, implementations may tend to generate surfaces that are too smooth. This situation may arise when the intended surface contains shapes similar to regular geometric primitives such as cylinders, spheres, flat planes etc. By minimizing bending energy, the surface may overshoot the intended shape and even undulate. For target shapes that are generally more organic in nature, these deformations fit well and are in fact desirable. However, if regular geometric shapes are the intended result, implementations have to provide additional post-process deformations.

In order to achieve this, implementations include a variation of the well-known Laplacian surface editing technique referred to as Laplacian fitting. This technique involves solving a Poisson problem in which implementations reconstruct the surface subject to a modified Laplacian designed to reproduce the regular geometric shapes of the target cage. For example, there may be a flat disk that is distorted, and there may be correction by Laplacian fitting. Such correction may be visible at both an isometric view and at a cross-sectional view. Some implementations may modify the Laplacian being used such that it reflects the surface features to be reproduced (like creases and flat areas) which would otherwise be smoothed out by the optimization.

Implementations enforce the appropriate geometric properties with Laplacian fitting by constraining the so-called delta-coordinates in Δxᵢ=δᵢ (Equation 7) to values that reflect the appropriate shape and solving for the coordinate function (x in Equation 7) that satisfies the Poisson problem.

This approach includes that implementations have some variant of the target head that exhibits these appropriate geometric properties. However, if implementations already had such a version of the target head, implementations do not solve for that version of the target head in the first place. Implementations do have something close to this version of the target head, however, in the form of the bindings already created for the wrap deformer.

Implementations previously evaluated these bindings to deform the template mesh to the target mesh, establishing the delta constraints for the thin-shell optimization (as a type of radial basis function optimization). This evaluation preserved the relative offsets of the surface from the cage subdivision surfaces the offsets were bound to. However, if implementations evaluate these bindings without maintaining the offset, implementations effectively shrink wrap the head to the cage subdivision surface which has the local curvature gradients implementations are looking for.

Solving Equation 7 with these values only recovers the shrink wrapped surface, hence this is not sufficient. Instead, implementations add position constraints to the system as illustrated for the left-hand side (LHS) in

$$\tilde{L} = [ \begin{matrix}L \\ ω {I}_{mxm} 0\end{matrix} ] \qquad ( Equation 8 )$$

and the right-hand side RHS in

$$\tilde{L} = [ \begin{matrix}δ \\ ω {c}_{1 : m}\end{matrix} ] . \qquad ( Equation 9 )$$

Implementations take these constraints from the selection of delta constraints used in the thin-shell optimization (as a type of radial basis function optimization) using the same weights (ω in Equations 8 and 9) as were used for the delta constraints.

Finally, implementations solve this system in a least-squares sense for the coordinate function (\tilde{L}^{T}\tilde{L})x=\tilde{L}^{T}δ (Equation 10) by finding x in Equation 10 that satisfies these constraints. The result is a surface that best fits the local curvatures gradient constraints obtained from the shrink wrapped version of the target head mesh and preserves the deformations established in the surface-based deformation and (optionally) the weighted implicit surface tracking projection.

Post-processing may be applied either by implicit surface tracking or Laplacian fitting depending on the user's intentions.

The template head mesh may contain multiple connected components. In addition to the skin, there may be any number of components representing features of the head such as: eyeballs, teeth, and a tongue. These components are often handled differently than the skin (and possibly handled differently from each other). While these components follow the deformations applied to the skin in order to fit the new shape, implementations cannot distort them in an unnatural manner.

For example, there may be eyeball components of the template head. If the region around the eye sockets is scaled up and shifted laterally in the target head, the eyeball components are to be scaled up and translated in a similar fashion. Otherwise, the eyeball components no longer fit within the eye sockets.

However, if implementations simply deform the eyeball components the same way that the implementations deform the surrounding skin mesh, the eyeball components no longer remain spherical (assuming the eyeball components were spherical to begin with and not a stylized shape). Such an approach does not work with animation that rotates the eyeballs about their center when the avatar looks in different directions.

A slightly different situation occurs with the teeth (which are often modeled as a single unit for the top teeth, and a second unit for the bottom teeth). The issue with the teeth may not be related to animation. Instead, issues with modeling teeth may have more to do with expectations about how hard materials like teeth can reasonably be reshaped.

Implementations handle the issue of reshaping these additional components by first permitting them to determine how the components deform in order to fit the skin shape. Then, implementations fit a rigid affine transformation to the deformed shape and apply the rigid affine transformation instead of the non-rigid deformation (thus “un-deforming” the component).

The rigid transform fitting may be calculated using a Procrustes method finding the optimal rotation via singular value decomposition (SVD) of a weighted cross-covariance matrix of vertex positions (rest shape and deformed shape). Depending on the specifications of the component, size may be adjusted either as non-uniform scaling for semi-rigid deformations (e.g., teeth), or as uniform scaling for fully rigid deformations (e.g., spherical eyeballs).

Contact is maintained with the skin surface by applying an RBF-based space deformation, defined by the un-deformation deltas of the (semi-) rigid component, to the local contact interface region of the skin that is to remain in contact.

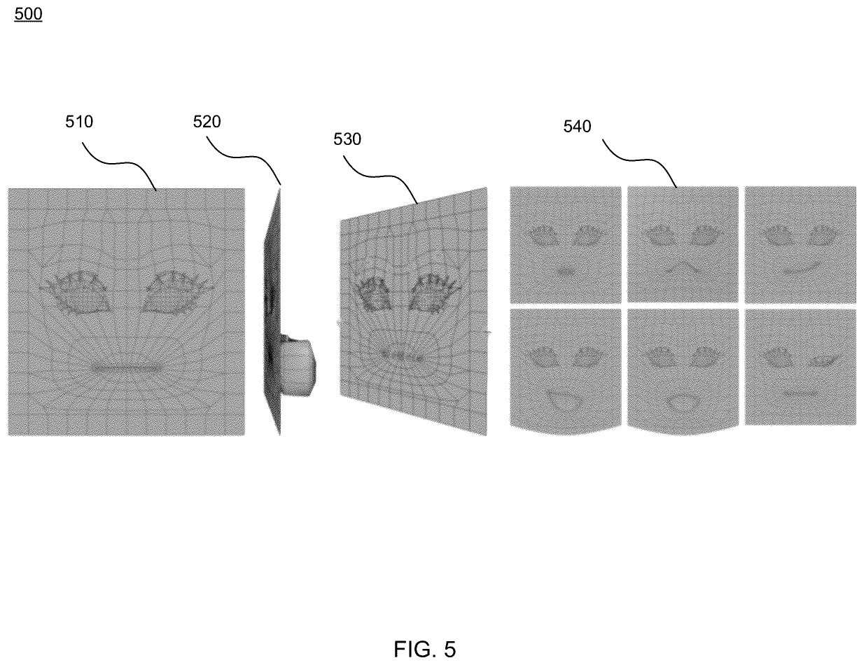

### FIG. 5—Example Flat Panel Mesh and Rig

FIG. 5 illustrates an example of a flat panel mesh and a rig 500, in accordance with some implementations. FIG. 5 illustrates using an automated processing pipeline to stitch an animatable face and its rig to a head shape mesh. The creation of the animatable face mesh and rig may be simplified to being primarily a flat square face surface, as illustrated in FIG. 5.

FIG. 5 illustrates a front view 510, a side view 520, the rig joints 530, and facial action coding system (FACS) poses 540 that when blended together, create facial expressions. Although 6 FACS poses 540 are illustrated in FIG. 5, such is only an example, and anywhere between 85 to 120 poses (again as an example) may be defined for use in a rig-retargeting solver.

Using the technique illustrated in FIG. 5, the curvature of any particular head shape does not have to be handled during rigging and animation. These flat panel face rigs of FIG. 5 may be 2.5D (two-and-a-half dimensional) as there is some depth for the mouth bag and the teeth/tongue parts inside as well as off-surface components for eye-parts and other facial features. 2.5D perspective refers to gameplay or movement in a video game or virtual reality environment that is restricted to a two-dimensional plane with little or no access to a third dimension in a space that otherwise appears to be three-dimensional and is often simulated and rendered in a 3D digital environment.

The animation used for the eyes, brows, and nose of the face may be primarily 2D, that simplifies the process of rigging, skinning, and animating. By design, the main surface of the flat panel face mesh and rigs may be squares so that the xy-coordinates of the vertices are exactly the corresponding uv-coordinates in UV space.

With the flat panel face mesh and rig created, next is an automated method to stitch the flat panel face rigs to the existing head shapes. An automated processing pipeline stitches the flat panel face mesh and rigs onto the head shape meshes as defined by the UV mapping, similar to how an actual texture is applied to a mesh. Given a flat face panel mesh and a target head shape, the automated pipeline generates a fully rigged and animatable stitched head.

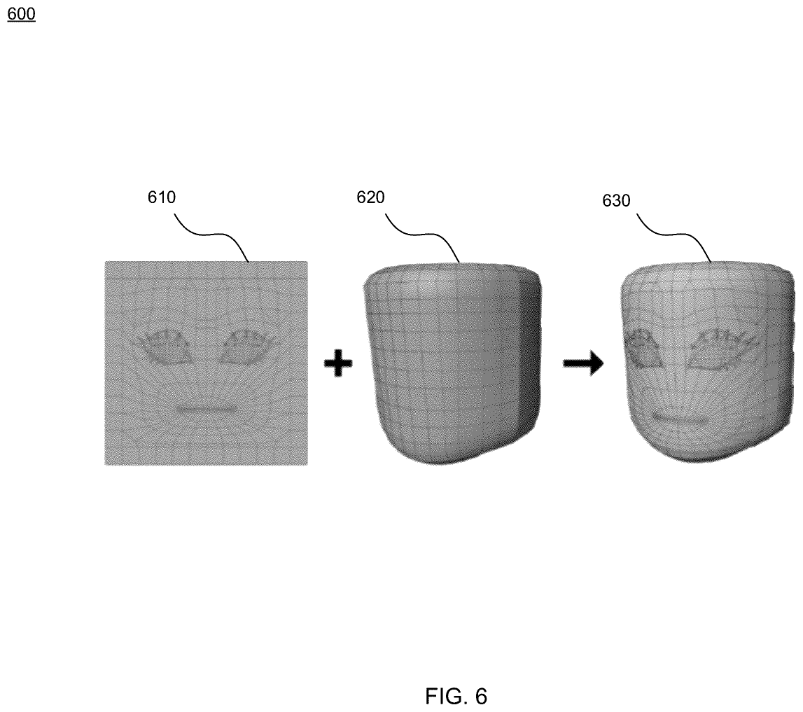

### FIG. 6—Automated Processing Pipeline to Deform Geometry of Flat Face Panel

FIG. 6 illustrates an example of an automated processing pipeline to deform the geometry of a flat face panel 600, in accordance with some implementations. FIG. 6 illustrates an example of an automated processing pipeline to deform the geometry of a flat face panel, in accordance with some implementations. For example, the flat face panel 610 is retargeted onto a head shape 620 with obtained UV mapping. The retargeting results in a fully rigged and animated stitched head with facial expressions 630.

Some technical challenges for this processing pipeline and techniques may include the following. First, flat panels are deformed onto the arbitrarily shaped surface of a head shape mesh. If the flat panels were very thin, this is a straightforward mapping via UV coordinates and signed normal distance from the face's surface.

However, the flat panels are 2.5D and may have an inner mouth bag with teeth and tongue parts. Determining how these parts deform when the face surface is stitched onto a curved surface is a challenge. To resolve the issue, the flat face panel's rig is retargeted, so that the resulting facial expressions on the stitched head look good (that is, in keeping with the user's intentions). Because implementations are to be designed to be able to stitch the flat face panels to any arbitrary head shape, implementations may use a general methodology that can account for wide curvature differences and anisotropic scaling. For example, implementations may be designed to work with a wide variety of head shapes and poses.

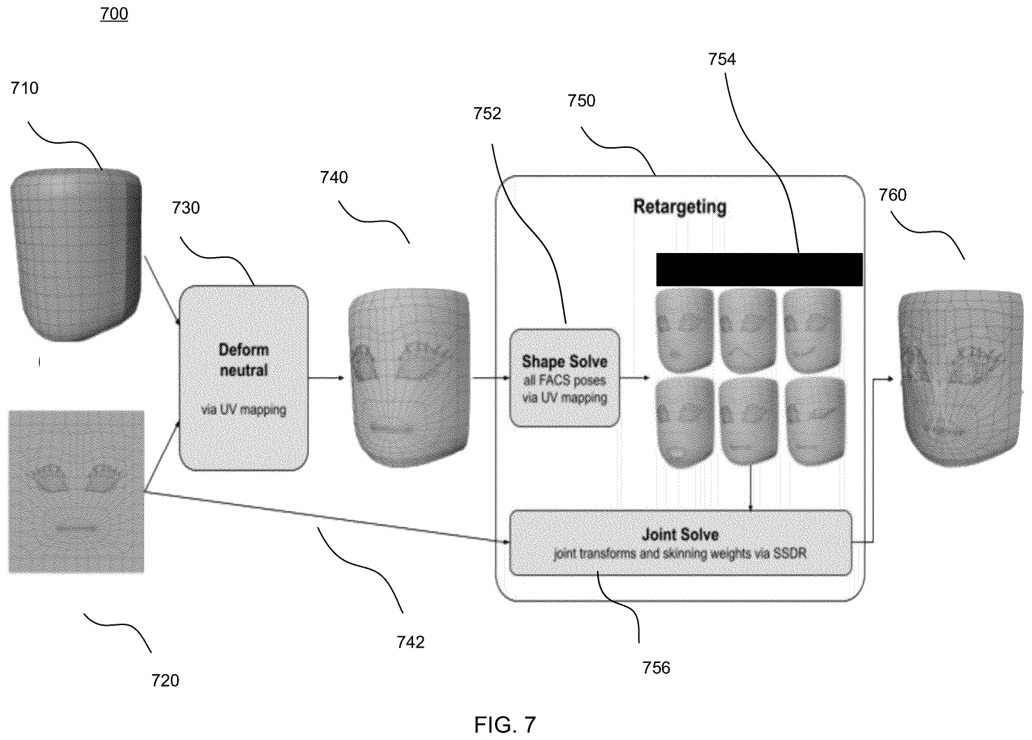

### FIG. 7—Further Details of Automated Processing Pipeline

FIG. 7 illustrates further details of the automated processing pipeline 700, in accordance with some implementations. In FIG. 7, the first part of the automated processing pipeline deforms the flat face panel rig 720 in a neutral pose to the head shape 710 and then retargets the rig. For example, automated processing pipeline 700 begins with head shape 710 and flat face panel rig 720. The head shape 710 and the flat face panel rig 720 are provided to a deform neutral process 730 that uses UV mapping. The result of the deform neutral process 730 is a deformed neutral 740. The deformed neutral 740 has no rig, no skinning and no poses.

A deform neutral 740 may be found as follows. Given a head shape mesh 710 and a flat face panel mesh and rig 712, this step finds the mapping of the vertices {b⁽ⁱ⁾}ᵢ₌₁^{N} of the flat face panel mesh and rig 712 in neutral pose to vertices {c⁽ⁱ⁾}ᵢ₌₁^{N} of the deformed neutral 740. A key part of the solution is to extend the domain D⊂R³ of this mapping to include the relevant input space coordinates, which for this problem is the subset with xy-coordinates in the unit square [0,1]².

Hence, implementations are designed to find a space deformation function ƒ_{deform}:D→R³ that maps a 3D in the world coordinates of the flat face panel 712 to a 3D point in the deformed space 740. This function is to be constrained so that for every vertex i, implementations have ƒ_{deform}:(b⁽ⁱ⁾)=c⁽ⁱ⁾. There are many different choices for ƒ_{deform} which can satisfy the above constraints, including radial basis functions, mean value coordinates, harmonic coordinates, and Green coordinates.

However, for the problem discussed herein, implementations can find this mapping using the UV map and signed distance from the main face surface. The flat face panel is constructed so that the xy coordinates (bₓ, b_{y}) map directly to the UV coordinates, and the z-coordinate is equal to zero for points on the main face surface. Specifically, let c_{surface}=gₘₐₚ(u, v) be the function that returns the 3D coordinate c_{surface}=[cₓ,c_{y},c_{z}]^{T} on the surface of the head shape given the UV coordinates u, v∈[0,1].

Also, let normal_{head}(u, v) return the normal vector on the surface of the head for the UV coordinate. Note that the image of the function gₘₐₚ for u, v∈[0,1] is the golden surface on the head shape 710. Then, the space deformation is given by ƒ_{deform}(b)=gₘₐₚ(bₓ, b_{y})+s·bₓ·normal_{head}(bₓ, b_{y}) where s is a scalar factor that takes into account the global scale difference between the flat-face panel and the face part of the head shape.

In words, for a point s in the input space, implementations first find the point on the head surface c_{surface} with the same UV coordinate, then translate along the surface normal of the head by a scale factor of the original signed distance b_{z} on the flat face panel. With ƒ_{deform}, implementations can compute the deformed neutral 740 from the flat face panel neutral.

The deformed neutral 740 is provided as input to a retargeting process 750. In addition, joint and skinning information 742, including a joint hierarchy and initial skinning weights, is provided to the retargeting process 750. The retargeting process 750 includes performing a shape solve operation 752 on the deformed neutral 740. In the shape solve operation 752, there may be a mapping ƒ_{deform} as computed in the previous section that maps every vertex in every FACS pose of the flat panel face to the deformed space. This results in a set of deformed pose shapes 754, one for every FACS pose.

The deformed neutral 740 and each target pose shape in the set of deformed pose shapes 754 serve as the groundtruth shapes to optimize the joint transforms for every pose and vertex skinning weights in order to construct a linear blend skinned rig. Implementations reuse the joint structure of the original flat face panel rig 720 and use an iterative technique to find the corresponding joint transforms and vertex skinning weights.

Implementations solve for the shapes of each FACS pose first in the shape solve step, and subsequently, use those shapes as the constraint to optimize for the joint transforms and skinning in the joint solve operation 756. This approach effectively decouples what the FACS pose looks like from the underlying deformer type and parameters that deform the neutral to a pose. Specifically, for a linear blend skinning rig, the joint solve may effectively find the best combination of rotations and translations to deform the neutral to the pose shape.

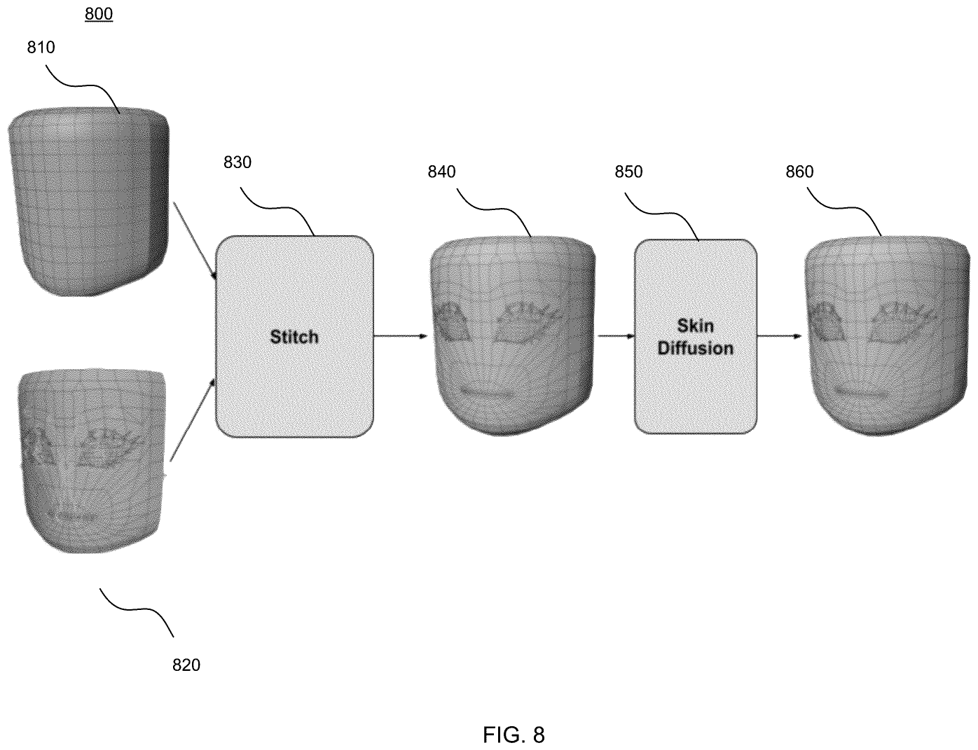

The joint solve operation 756 manages joint transforms and skinning weights via Smooth Skinning Decomposition with Rigid Bones (SSDR). The joint solve operation may include using the deformed neutral and the set of deformed pose shapes to serve as the groundtruth shapes to construct a linear blend skinned rig for the target avatar. Thus, the joint solve operation 756 generates, as its output, a deformed face rig 760. The deformed face rig 760 may serve as an input to the continuation of the automated processing pipeline presented in FIG. 8.

### FIG. 8—Further Details of Automated Processing Pipeline

FIG. 8 illustrates still further details of the automated processing pipeline 800, in accordance with some implementations. In FIG. 8, the second part of the automated processing pipeline performs a stich operation 830 that stitches the deformed face rig 820 to the head shape 810 to generate a stitched head rig 840. The deformed face rig 820 may correspond to the deformed face rig 760 generated by processing pipeline 700 as discussed in FIG. 7. The automated processing pipeline applies some skin diffusion 850 around the edges of where the deformed face rig was stitched to get a smooth fall off for deformation in final result 860.

To complete the pipeline, the pipeline then stitches the target face rig into the UV mapped region of the head shape to get the complete head. It may be relevant to diffuse the skin weights around the border and even interior of the deformed face panel to get good looking deformations on head shapes. Such diffusion may be particularly relevant for head shapes that have a chin. For example, there may be an instance in which lower teeth crash through a chip if skin weights are not adjusted properly.

Additional details are now provided for specific aspects of stitch and skin diffusion according to various implementations. To complete the automated processing pipeline, the target face rig is stitched into the UV mapped region of the head shape to get the complete head. The skin weights are diffused around the border and even interior of the deformed face panel to get good looking deformations on head shapes, particularly for head shapes that have a chin. Otherwise, the lower teeth may crash through the chin if the skin weights are not adjusted properly.

Since the skinning weights only exist on the solved face panel vertices, the automated processing pipeline blends those weights outward, across the stitching boundary, to ensure that deformations at the boundary of the original face panel are propagated naturally to the surrounding head mesh.

Ideally, diffusion simply involves smoothing the weights outward (e.g., a certain number of face-neighbors or geodesic distance) while constraining the face panel to remain unaltered. However, such simple rules do not work globally. Instead, skin diffusion is to be head shape dependent. This approach is complicated, however, because the original weights were designed to deform the face panel in isolation as it is quite difficult for an artist to design them to blend with even a single yet-to-be-stitched head shape, and likely difficult to do so for an entire range of varied shapes. The automated processing pipeline thus uses a head shape dependent “blending mask.”

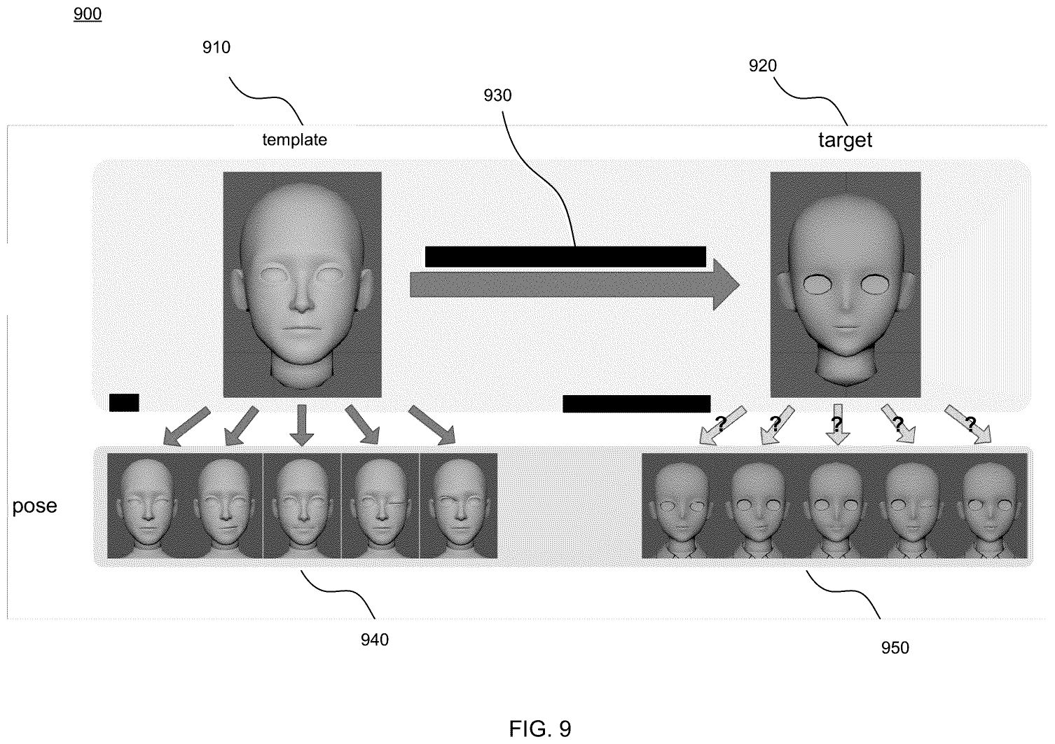

### FIG. 9—Shape Transfer by Leveraging Existing Dynamic Heads

FIG. 9 illustrates an example of shape transfer by leveraging existing dynamic heads 900, in accordance with some implementations. For example, there may be a template head 910 and a target head 920. The template head 910 and the target head 920 may have a same topology and have vertex correspondence.

Each of the template head 910 and the target head 920 may be originally presented as having a neutral expression. There are a variety of mappings mapping the template neutral to poses. These mappings provide poses 940 that are variants of the template head 910. Because there is a correspondence between the template head 910 and the target head 920, it is possible to generate poses 950 that resemble poses 940, but in the context of target head 920.

Creating rigs, skinning, and poses may be difficult and time consuming. These technologies may leverage the combinatorics of face components. A problem confronted is, given a template head 910 and a target head 920, how can implementations transfer the rig and get facial expressions on the target. To solve the problem, one can leverage existing dynamic heads.

Implementations begin with a template neutral and a target neutral. The template neutral head is associated with various poses. With this information, the target neutral head may be used as a basis to generate target head poses that are similar poses to those of the template neutral head, but for the target head. Such target head poses may be identified based on the same topology and vertex correspondence, as explained in greater detail herein.

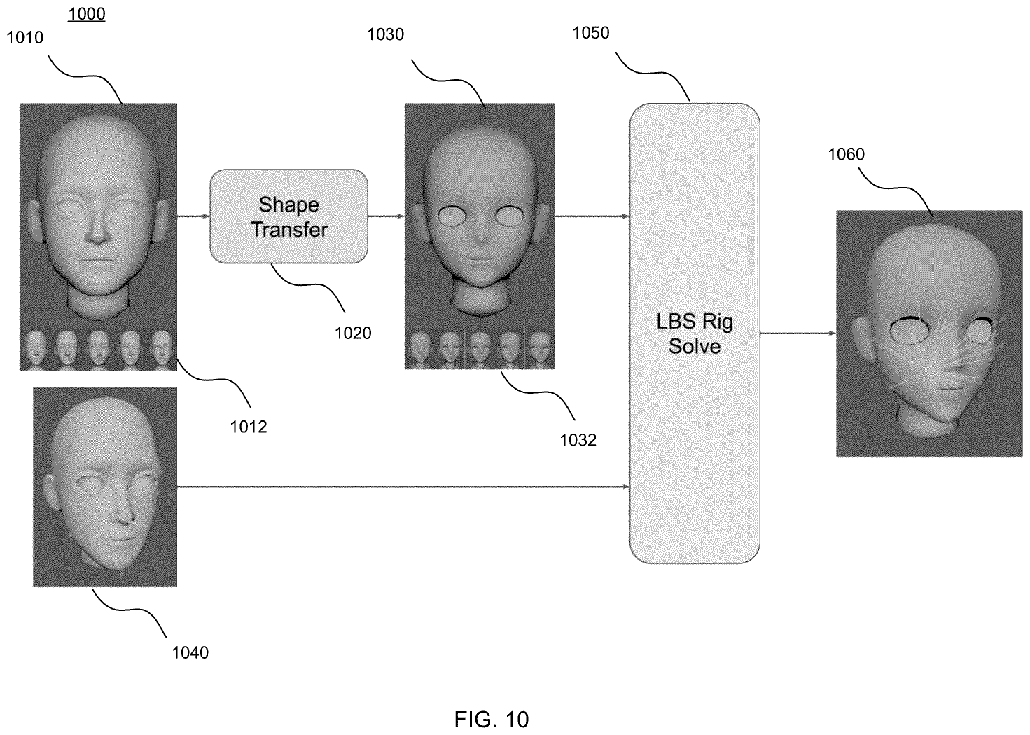

### FIG. 10—Two-Step Approach Including Shape Transfer and Linear Blend Skinning (LBS) Rig Solve

FIG. 10 illustrates an example of a two-step approach including shape transfer and a linear blend skinning (LBS) rig solve 1000, in accordance with some implementations. For example, FIG. 10 illustrates a face with a neutral pose 1010 and various poses 1012 of that face. The neutral pose 1010 and the various poses 1012 are supplied for a shape transfer 1020 operation. The shape transfer 1020 operation results in a transferred shape 1030 and transferred poses 1032. For example, these may correspond to a template head and a target head.

There may also be a destination pose 1040. The transferred shape 1030, the transferred poses 1032, and the destination pose 1040 are supplied to an LBS rig solve operation 1050. The LBS rig solve operation 1050 generates a pose with the transferred rig 1060.

The shape transfer 1020 may include capturing the mapping that takes template neutral vertices to target neutral vertices. Thus, there may be n template vertices and n corresponding target vertices. The shape transfer 1020 may use a corresponding space deformation approach.

The space deformation approach finds a function ƒ:R³→R³ that maps each template vertex xᵢ to target vertex yᵢ such that yᵢ=ƒ(xᵢ). A radial basis function (RBF) is one such function that may be used (parameterized by wⱼ, cᵢ, A, b) where y=ƒ(x)=SUMⱼwⱼ∥x−cⱼ∥+Ax+b. Note that f(x) is defined for every x in R³, not just at the template vertices xᵢ. Having vertex-to-vertex correspondence also means implementations have triangle-to-triangle correspondence between template and target faces. For example, there may be a gradient transfer approach to compute the FACS shapes. There may also be techniques including Neural Jacobian Fields or as-rigid-as-possible (ARAP++) approaches.

The linear blend skinning (LBS) rig solve operation 1050 takes as given skinning weights from the original (source) template, a joint hierarchy from an original (source) template, and template/target vertex position pairs for every pose. The LBS rig solve operation 1050 may use an optimization result in transforms of every joint for every pose and for updated skinning weights.

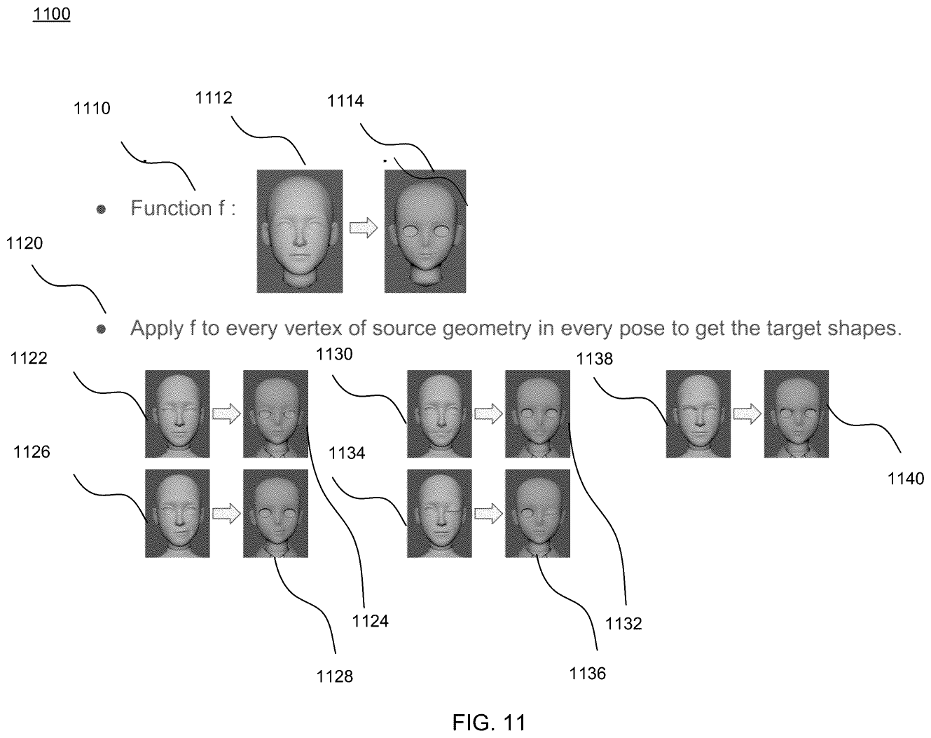

### FIG. 11—Function for Shape Transfer Via Space Deformation

FIG. 11 illustrates an example function that performs shape transfer via space deformation 1100, in accordance with some implementations. For example, there may be a function f 1110 (as discussed herein) that deforms space to map a first face 1112 to a target face 1114. At 1120, f is applied to every vertex of template geometry in every pose to obtain the corresponding target shape.

For example, template pose 1122 maps to target pose 1124, template pose 1126 maps to target pose 1128, template pose 1130 maps to target pose 1132, template pose 1134 maps to target pose 1136, and template pose 1138 maps to target pose 1140. Such a mapping provides similar poses to those from the template face, but in the context of the target face.

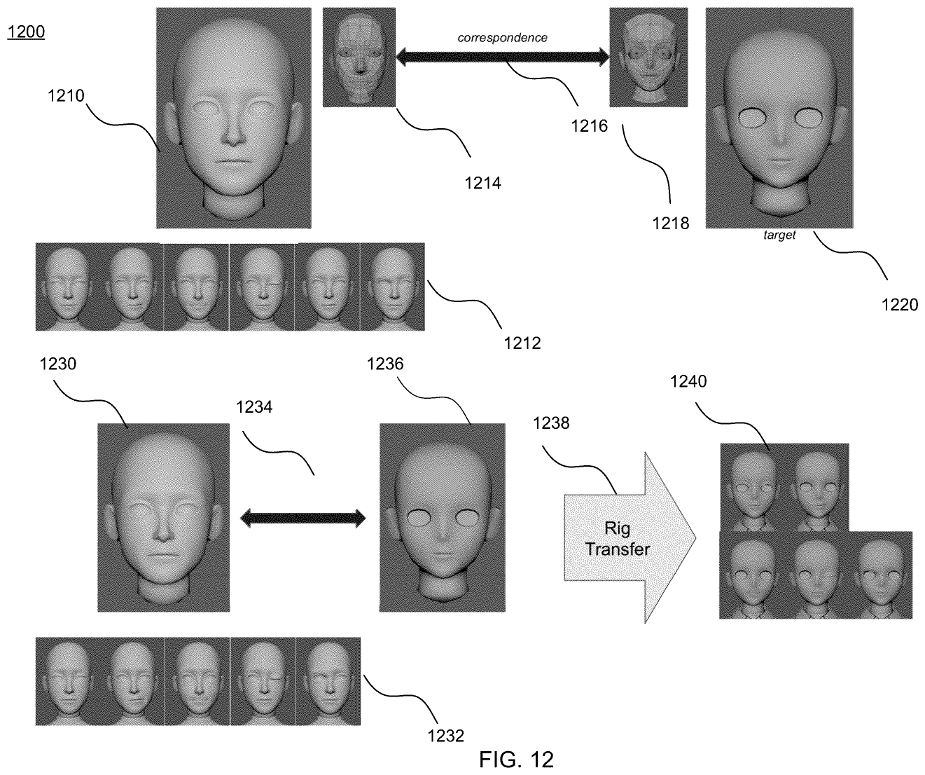

### FIG. 12—Rig Transfer Technology

FIG. 12 illustrates rig transfer technology that, given correspondence between neutral expressions, automatically transfers rig and skinning and poses to a target 1200, in accordance with some implementations. For example, FIG. 12 illustrates a template face 1210, template poses 1212, and template cage 1214. There may be a correspondence 1216 between template cage 1214 and target cage 1218. Such a correspondence provides for generation of a target face 1220 using target cage 1218 based on the correspondence.

FIG. 12 illustrates additional aspects of using the correspondence between the template and the target. For example, there is a template face 1230 having a neutral pose. The template face 1230 is associated with a number of template poses 1232, having a variety of facial expressions. There is a vertex correspondence 1234 between template face 1230 in the neutral pose and the target face 1236 in the neutral pose. Hence, it is possible to do a rig transfer 1238 operation that results in a number of target poses 1240. The template poses 1232 and target poses 1240 have similar facial expressions, but the poses resemble the template face 1230 and the target face 1236, respectively.

For example, the rig transfer begins with a template (as a source) associated with a neutral pose that has been rigged and posed into several poses. A cage morphing or UV mapping provides a morphed versions of the template neutral to the target neutral. A function f is identified that can map each vertex of the source neutral exactly to the corresponding vertex of the target neutral. Thus, the function f is a mapping from R³→R³. If f is defined over all of R³, then implementations can transform the vertices of any pose of the source to the vertices of the target. Some implementations may use a radial basis function (RBF) with a linear kernel for the function f.

A joint solve may be performed so that the RBF function maps each vertex of the template neutral face to each corresponding vertex of the target neutral face. Hence, once the function f is identified, the function may be applied appropriately to generate target poses 1240 by performing a rig transfer 1238 based on the template face 1230 and the target face 1236, based on the vertex correspondence 1234 and the template poses 1232.

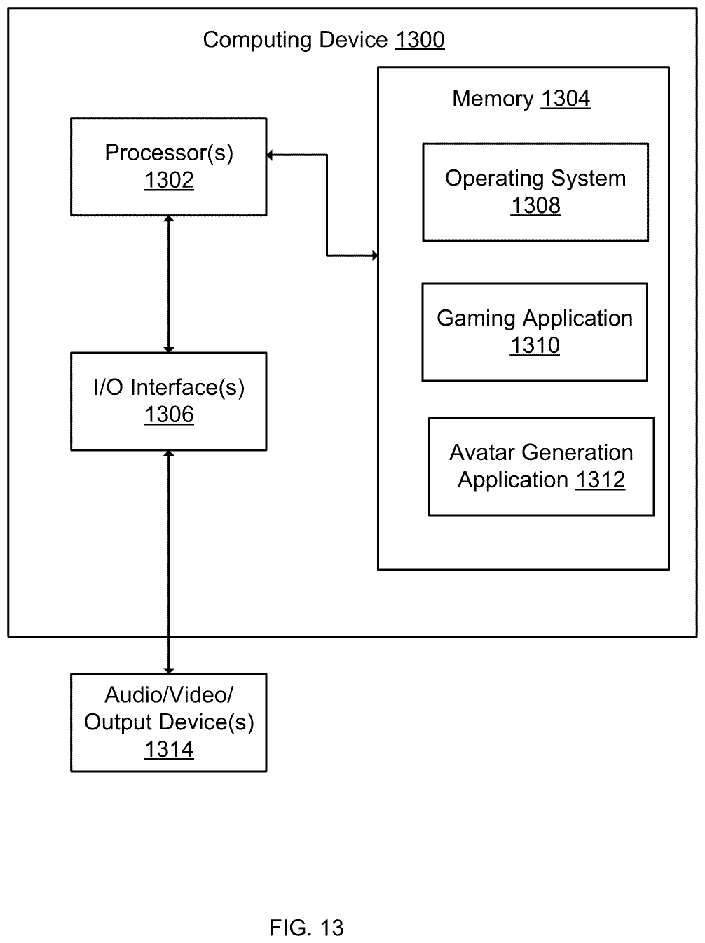

### FIG. 13—Example Computing Device

FIG. 13 is a block diagram that illustrates an example computing device 1300, in accordance with some implementations.

FIG. 13 is a block diagram of an example computing device 1300 which may be used to implement one or more features described herein. In one example, device 1300 may be used to implement a computer device (e.g., 102 and/or 110 of FIG. 1), and perform appropriate method implementations described herein. Computing device 1300 can be any suitable computer system, server, or other electronic or hardware device. For example, the computing device 1300 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 1300 includes a processor 1302, a memory 1304, input/output (I/O) interface 1306, and audio/video input/output devices 1314.

Processor 1302 can be one or more processors and/or processing circuits to execute program code and control basic operations of the device 1300. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1304 is typically provided in device 1300 for access by the processor 1302, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1302 and/or integrated therewith. Memory 1304 can store software operating on the server device 1300 by the processor 1302, including an operating system 1308, one or more applications 1310, e.g., an avatar generation application 1312. In some implementations, application 1310 can include instructions that enable processor 1302 to perform the functions (or control the functions of) described herein, e.g., some or all of the methods described with respect to FIGS. 2 and 3.

For example, applications 1310 can include an avatar generation application 1312, which as described herein can generate avatars within an online virtual experience server (e.g., 102). Elements of software in memory 1304 can alternatively be stored on any other suitable storage location or computer-readable medium. In addition, memory 1304 (and/or other connected storage device(s)) can store instructions and data used in the features described herein. Memory 1304 and any other type of storage (magnetic disk, optical disk, magnetic tape, or other tangible media) can be considered “storage” or “storage devices.”

I/O interface 1306 can provide functions to enable interfacing the server device 1300 with other systems and devices. For example, network communication devices, storage devices (e.g., memory and/or data store 120), and input/output devices can communicate via interface 1306. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 1314 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 13 shows one block for each of processor 1302, memory 1304, I/O interface 1306, and software blocks of operating system 1308 and virtual experience application 1310. These blocks may represent one or more processors or processing circuitries, operating systems, memories, I/O interfaces, applications, and/or software engines. In other implementations, device 1300 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 1300, e.g., processor(s) 1302, memory 1304, and I/O interface 1306. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1314, for example, can be connected to (or included in) the device 1300 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 200 and/or 300) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

We claim:

1. A computer-implemented method to create a variant of a template avatar, the method comprising:
obtaining a template avatar that includes a template geometry obtained from a mesh of the template avatar;
generating a template cage associated with the template avatar as a low-resolution approximation wrapped around the template geometry;
creating a target cage from the template cage by modifying the template cage based on input from a user; and
morphing the template geometry with the target cage to generate a target avatar that is a variant of the template avatar.

2. The computer-implemented method of claim 1, the computer-implemented method further comprising:
adjusting a rigging and a skinning of the target avatar to enable animation for the target avatar.

3. The computer-implemented method of claim 2, wherein the template avatar further includes a template head of the template avatar, wherein the target avatar comprises a target head of the target avatar, and wherein adjusting the rigging and skinning includes one or more of:
determining a pose of the target head based on a particular pose of the template head; and
determining a facial expression of the target head based on a particular facial expression of the template head.

4. The computer-implemented method of claim 2, wherein adjusting the rigging and the skinning of the target avatar comprises:
converting the mesh of the template avatar into a flat panel mesh;
deforming the flat panel mesh into a deformed neutral based on neutral poses of the target avatar;
performing retargeting on the deformed neutral to obtain a deformed rig of the template avatar;
stitching the deformed rig onto a shape of the target avatar to generate a stitched rig having rigging and skinning; and
after the stitching, performing skin diffusion on the stitched rig to obtain the target avatar.

5. The computer-implemented method of claim 4, the computer-implemented method further comprising:
defining a space deformation function that maps a point in 3D world coordinates of the flat panel mesh to a 3D point in the deformed neutral; and
using the space deformation function to deform the flat panel mesh into the deformed neutral.

6. The computer-implemented method of claim 5, wherein the template avatar is associated with a plurality of poses encoded via facial action coding system (FACS) and wherein performing retargeting comprises:
performing a shape solve operation using the space deformation function to map a respective pose of the plurality of poses to generate a set of deformed pose shapes; and
performing a joint solve operation comprising using the deformed neutral and the set of deformed pose shapes to serve as groundtruth shapes to construct a linear blend skinned rig for the target avatar.

7. The computer-implemented method of claim 1, wherein morphing the template geometry of the template avatar with the target cage to generate the target avatar comprises using at least one surface-based deformation technique.

8. The computer-implemented method of claim 7, wherein the using at least one surface-based deformation technique comprises performing wrap deformation to provide a wrap deformed version of the template avatar and selecting a sparse subset of deltas based on the wrap deformed version of the template avatar.

9. The computer-implemented method of claim 7, wherein the at least one surface-based deformation technique comprises variational optimization.

10. The computer-implemented method of claim 9, wherein the variational optimization includes radial basis function optimization to find a displacement field and applies the displacement field to the template avatar to generate the target avatar.

11. The computer-implemented method of claim 10, further comprising performing at least one of implicit surface tracking or Laplacian fitting.

12. The computer-implemented method of claim 11, wherein performing the implicit surface tracking comprises:
generating a first implicit surface based on the template cage;
adding embedded isovalues of vertices of the template avatar to the first implicit surface;
generating a second implicit surface based on the target cage; and
projecting vertices of the target avatar towards corresponding isovalues in the second implicit surface based on the first implicit surface and the embedded isovalues of the first implicit surface.

13. The computer-implemented method of claim 11, wherein the Laplacian fitting comprises solving a Poisson problem to reconstruct the target avatar based on a modified Laplacian designed to reproduce regular geometric shapes of the target cage by producing a surface for the target avatar that satisfies delta fit constraints.

14. A non-transitory computer-readable medium with instructions stored thereon that, responsive to execution by a processing device, causes the processing device to perform operations comprising:
obtaining a template avatar that includes a template geometry obtained from a mesh of the template avatar;
generating a template cage associated with the template avatar as a low-resolution approximation wrapped around the template geometry;
creating a target cage from the template cage by modifying the template cage based on input from a user; and
morphing the template geometry with the target cage to generate a target avatar that is a variant of the template avatar.

15. The non-transitory computer-readable medium of claim 14, wherein the operations further comprise adjusting a rigging and a skinning of the target avatar to enable animation for the target avatar.

16. The non-transitory computer-readable medium of claim 15, wherein adjusting the rigging and the skinning of the target avatar comprises:
converting the mesh of the template avatar into a flat panel mesh;
deforming the flat panel mesh into a deformed neutral based on neutral poses of the target avatar;
performing retargeting on the deformed neutral to obtain a deformed rig of the template avatar;
stitching the deformed rig onto a shape of the target avatar to generate a stitched rig having rigging and skinning; and
after the stitching, performing skin diffusion on the stitched rig to obtain the target avatar.

17. The non-transitory computer-readable medium of claim 14, wherein morphing the template geometry of the template avatar with the target cage to generate the target avatar comprises using at least one surface-based deformation technique.

18. A system comprising:
a memory with instructions stored thereon; and
a processing device, coupled to the memory, the processing device configured to access the memory and execute the instructions, wherein the instructions cause the processing device to perform operations including:
obtaining a template avatar that includes a template geometry obtained from a mesh of the template avatar;
generating a template cage associated with the template avatar as a low-resolution approximation wrapped around the template geometry;
creating a target cage from the template cage by modifying the template cage based on input from a user; and
morphing the template geometry with the target cage to generate a target avatar that is a variant of the template avatar.

19. The system of claim 18, wherein the operations further comprise adjusting a rigging and a skinning of the target avatar to enable animation for the target avatar.

20. The system of claim 19, wherein adjusting the rigging and the skinning of the target avatar comprises:
converting the mesh of the template avatar into a flat panel mesh;
deforming the flat panel mesh into a deformed neutral based on neutral poses of the target avatar;
performing retargeting on the deformed neutral to obtain a deformed rig of the template avatar;
stitching the deformed rig onto a shape of the target avatar to generate a stitched rig having rigging and skinning; and
after the stitching, performing skin diffusion on the stitched rig to obtain the target avatar.
